(19) United States
(12) Patent Application Publication
(10) Pub. No.: US 2014/0029307 A1
(43) Pub. Date: Jan. 30, 2014

(54) THIN LIGHT GUIDE DEVICE UTILIZING LED FLASH ON A PORTABLE ELECTRONIC APPARATUS

(71) Applicant: SHAU-FA YU, Taipei City (TW)

(72) Inventor: SHAU-FA YU, Taipei City (TW)

(21) Appl. No.: 13/944,165

(22) Filed: Jul. 17, 2013

(30) Foreign Application Priority Data
Jul. 24, 2012 (TW) 101214313

(51) Int. Cl. F21V 8/00; F21V 7/00

(52) U.S. Cl. CPC G02B 6/0011; F21V 7/0075
USPC 362/623; 362/577

(57) ABSTRACT

A thin light guide device applying LED flash on a portable electronic apparatus is to utilize a reflection unit such as a mirror to change forward direction of the light emitting from a LED flash, thereby making the LED flash capable of providing illumination, decoration and light source projecting to the display for enhancing functions of the LED flash.

### CROSS-REFERENCE TO RELATED APPLICATIONS

The application claims priority from Taiwan Patent Application No. 101214313 filed on Jul. 24, 2012, the disclosure of which is incorporated herein by reference.

### BACKGROUND OF THE INVENTION

1. Field of the Invention

The present invention relates to a light guide device associated with a portable electronic apparatus, and, more particularly, to a thin light guide device capable guiding light emitting from a LED flash of the portable electronic apparatus.

2. Description of Related Art

The portable electronic apparatus such as the smartphone or tablet computer generally is equipped with a lens and a LED flash for taking images of objects whenever necessary, and the LED flash is capable of replenishing insufficient brightness of the taken objects whenever needed.

In order to allow the cell phone having a function of light projection, the LED light is applied as a light source for the cell phone. For instance, Taiwan Patent No. 1327018 discloses a cell phone with dual functions of photographing projecting which provides an auto focusing lens set, a photo sensor, a LED light source for projecting light, a LED projection system, a fixed focus lens set, and a reflection mirror in the main body; the light of the LED light source passes through the LED projection system and the fixed focus lens set, is reflected by the reflection mirror, and projects outward via the second lens; meanwhile, outward light shoots into the main body via the first and second lenses respectively, is reflected by pivotal reflection mirrors respectively, and images on the photo sensor via the auto focusing lens set.

In order to promote the function of the cell phone with picture taking, there is a protection case associated with a lens for the cell phone. For instance, Taiwan Utility Model No. M433575 discloses a curvy glass protection case which is joined to a lens and includes a curvy glass and a lens module; the curvy glass provides a hole or groove for accommodating the lens in the lens module; the lens aligns with the photographing lens of the electronic device; the lens module in combination with the photographing lens to perform image capturing work.

### SUMMARY OF THE INVENTION

In order to improve the function of the LED flash on the portable electronic device, the present invention is proposed.

The primary object of the present invention is to provide a thin light guide device applying LED flash on a portable electronic apparatus, wherein the thin light guide device includes a reflection unit such as a mirror utilized to change forward direction of the light emitting from a LED flash, and a light guide unit such as the backlight, light guide plate, light stick, light guide chamber with reflective interior, or photo fibers for guiding the light, thereby the LED flash capable of offering illumination, decoration for the portable electronic apparatus, light projection to the display or the hologram for enhancing functions of the LED flash.

Another object of the present invention is to provide is to provide a thin light guide device applying LED flash on a portable electronic apparatus, wherein the thin light guide device is capable of satisfying the photo path required by the hologram while imaging, that is, multiple reflection units and a light guide unit are employed to project the light emitting from the LED flash to the hologram within a short vertical distance between the LED flash and the hologram and to allow the hologram showing hologram figures while the portable electronic apparatus meets requirements of thinness, shortness and smallness as well.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of the first embodiment of a thin light guide device utilizing LED flash on a portable electronic apparatus according to the present invention;

FIG. 2 is a plan view illustrating a sliding part in association with an upper wall in the first embodiment;

FIG. 3 is a perspective view of the first embodiment of a light guide device capable of applying LED flash on a portable electronic apparatus according to the present invention;

FIG. 4 is a perspective view of the first embodiment illustrating a display unit presenting figures;

FIG. 5 is a plan view of the second embodiment of a light guide device applying LED flash on a portable electronic apparatus according to the present invention;

FIG. 6 is a perspective view of the second embodiment of a light guide device applying LED flash on a portable electronic apparatus according to the present invention;

FIG. 7 is a plan view of the third embodiment of a light guide device applying LED flash on a portable electronic apparatus according to the present invention;

FIG. 8 is a perspective view of the third embodiment illustrating a hologram showing hologram figures;

FIG. 9 is a plan view of the fourth embodiment of a light guide device applying LED flash on a portable electronic apparatus according to the present invention;

FIG. 10 is a perspective view illustrating the conventional way with which a light source shoots light to a hologram which then shows a hologram figure.

### DETAILED DESCRIPTION OF THE INVENTION

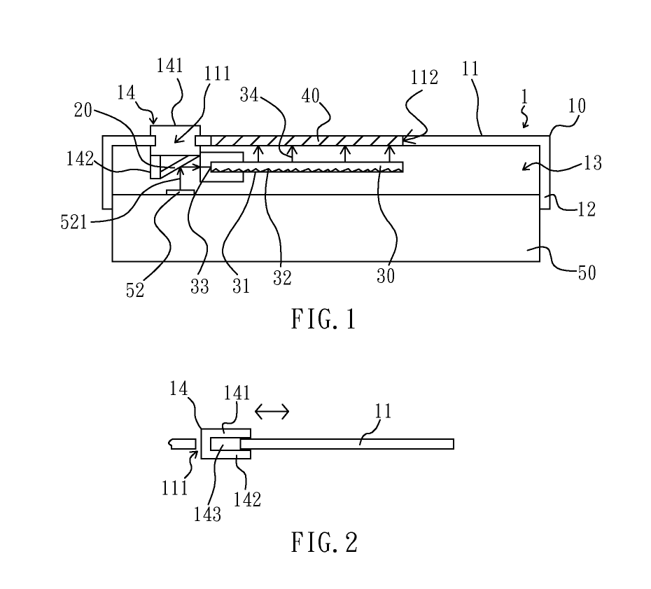

Referring to FIGS. 1 to 4, the first embodiment of a thin light guide device 1 applying LED flash on a portable electronic apparatus according to the present invention comprises a casing 10, at least a reflection unit 20, a light guide unit 30 and a display unit 40.

The casing 10 has an upper wall 11 and a lower peripheral wall 12 to define a containing space 13. The upper wall 11 further provides a first opening 111 and a second opening 112.

The light guide unit 30 of the present embodiment is a backlight with the bottom side 31 thereof being disposed with a light reflection structure 32. The light guide unit 30 is joined to the casing 10 or the lower end of a slide part 14. The first reflection unit 20 and the display unit 40 are disposed at a lateral side and over the light guide unit 30, respectively.

The casing 10 of the present embodiment is joined to the first reflection unit 20 via the slide part 14 as shown in FIG. 1. The slide part 14 has an upper section 141 and a lower section 142 with a slide groove 143 in between. The slide part 14 is associated with the upper wall 11 such as by way of the slide groove 143 fitting with the upper wall 11. The slide part 14 moves toward the first opening 111 relative to the upper wall 11 in a way of blocking or not blocking the first opening 111 as shown in FIG. 2

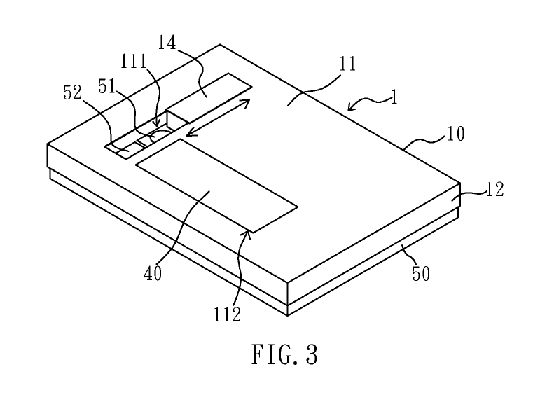

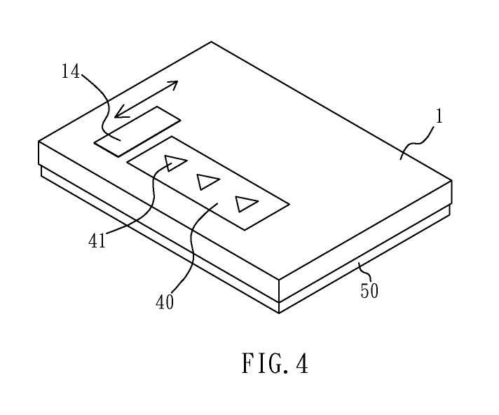

The casing 10 of the present embodiment as shown in FIG. 3 is associates with a portable electronic apparatus 50 which is a smartphone or a tablet personal computer (PC) with a lens 51 and a LED flash 52. When the first opening 111 is not blocked by the slide part 14, the lens 51 with the LED flash 52 takes images and projects light through the first opening 111.

As it is shown in FIG. 1 that the lower section 142 of the slide part 14 joins with the first reflection unit 20 and the light guide unit 30; the first reflection unit 20 corresponds to the LED flash 52, e.g. the first reflection unit 20 has an inclining angle to reflect light 521 emitting from the LED flash 52. When the slide part 14 blocks the first opening 111, the first reflection unit 20 is positioned over the LED flash 52, and the light 521 is reflected to a lateral side 33 of the light guide unit 30, then reflected by the light reflection structure 32 at the bottom side 31 of the light guide unit 30, and further guided to shoot homogenous light 34 above the guide light unit 30; the light 34 irradiates the display unit 40 as shown in FIG. 1 for the display unit 40 presenting brighter figures as shown in FIG. 4.

The casing 10 can be arranged without joining with the display unit 40 for homogeneous light 34 being guided to shoot upward the light guide unit 30 and outward the casing 10 via the second opening 112 by the light guide unit 30. In this way, the LED flash 52 provides an effect of illumination as well.

Referring to FIGS. 1, 5, and 6, the second embodiment of a thin light guide device 2 applying LED flash on a portable electronic apparatus according to the present invention comprises a casing 10, at least a reflection unit 20, and at least a light guide unit 35.

The casing 10 is associated with the first reflection unit 20 and the light guide unit 35, respectively; the first reflection unit 20 and the light guide unit 35 are received in a containing space 13. The light guide unit 35 of the present embodiment is formed of multiple optical fibers, and the casing 10 has a plurality of second opening 113 corresponding to the optical fibers.

The structure of the present embodiment is almost the same as the first embodiment shown in FIG. 1 except that the optical fibers are employed instead of the backlight, no display 40 is provided, and the casing 10 has the second openings 113 corresponding to the optical fibers. No details will be described further.

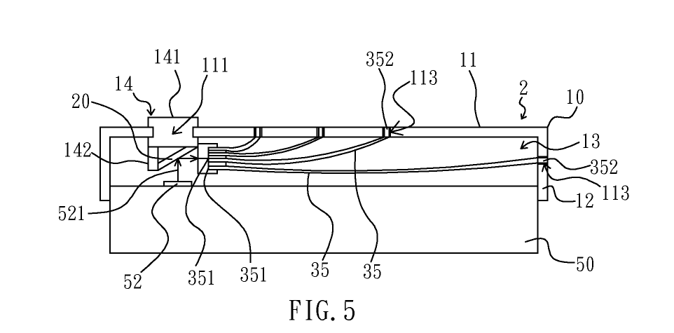

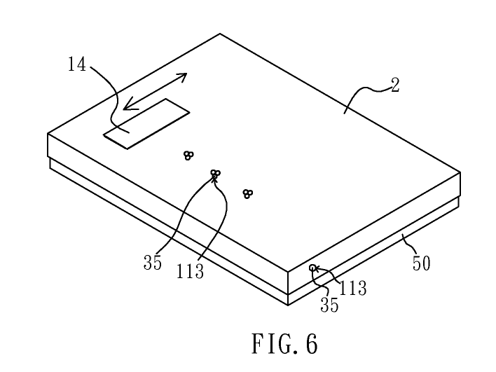

Referring to FIGS. 5 and 6 again, each of the light guide units 35 of the present embodiment has a first end 351 disposed beside the reflection unit 20 and a second end 352 placed at one of the second openings 113.

When the slide part 14 blocks the first opening 111, the reflection unit 20 is positioned right above the LED flash 52 to reflect the light 521 emitting from the LED flash light 52 to the first end 351 of the respective light guide unit 35, and then the light 521 is guided to the second end 352 of the respective light guide unit 35 to shoot outward via the second openings 113. The second openings 113 are provided to have shapes of figures to decorate the portable electronic apparatus 50 as shown in FIG. 6; when lights shining from the second openings, they appear decorative effects, especially it is in the dark.

Referring to FIGS. 1, 7, and 8, the third embodiment of a thin light guide device 3 applying LED flash on a portable electronic apparatus according to the present invention comprises a casing 10, at least a reflection unit 20, a light guide unit 60, a second reflection unit 70 and a hologram 80.

The casing 10 is associated with the first refection unit 20, the light guide unit 60, the second reflection unit 70, and the hologram 80, respectively; the first reflection unit 20, the light guide unit 60 and the second reflection unit 70 are disposed in the containing space 13. The hologram 80 is disposed to be visible from the outer side of the casing 10, correspond to the second opening 112, and capable of blocking the second opening 112.

The structure of the present embodiment is almost the same as the first embodiment shown in FIG. 1 except that the light guide unit 60 is the conventional light guide plate or light guide stick instead of the backlight, no display 40 is provided, and further comprises a second reflection unit 70 and a hologram 80. Therefore, no details will be described further.

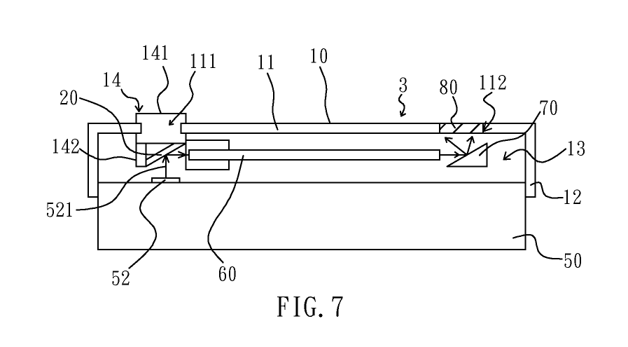

It can be seen in FIG. 7 that the first reflection unit 20 and the second reflection unit 70 are disposed at two opposite lateral sides of the light guide unit 60 respectively; the hologram 80 is disposed above the second reflection unit 70.

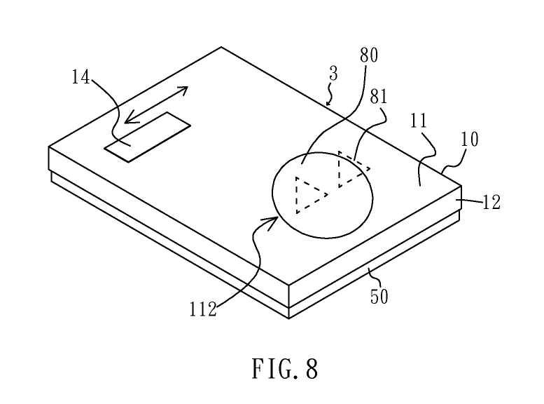

When the slide part 14 blocks the first opening 111, the first reflection unit 20 is positioned right above at least a LED flash 52 to reflect the light 521 emitting from the LED flash 52; then the light 521 is guided to the second reflection unit 70 by the light guide unit 60 and further reflected by the second reflection unit 70 to shoot the hologram 80 such that hologram FIGS. 81 appear above the hologram 80 as shown in FIG. 8.

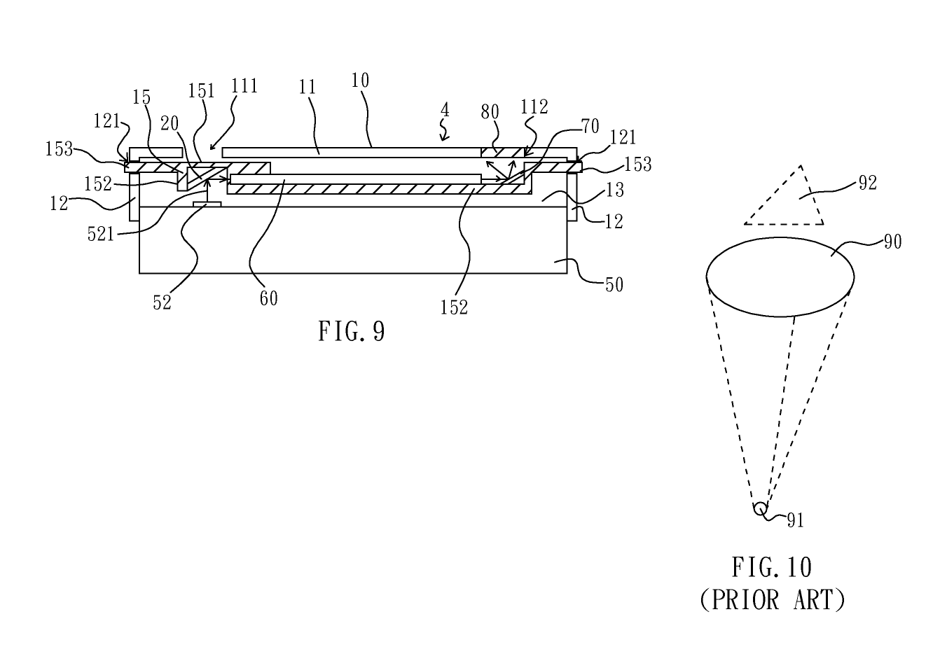

Referring to FIG. 9 in company with FIG. 7, the fourth embodiment of a thin light guide device 4 applying LED flash on a portable electronic apparatus according to the present invention comprises a casing 10, at least a reflection unit 20, a light guide unit 60, a second reflection unit 70 and a hologram 80.

The casing 10 is associated with the first refection unit 20, the light guide unit 60, and the second reflection unit 70 by way of the slide part 15; the first reflection unit 20, the light guide unit 60 and the second reflection unit 70 are disposed in the containing space 13.

The structure of the present embodiment is almost the same as the third embodiment shown in FIG. 7 except that the slide part 15 is different from the aforementioned slide part 14, wherein the slide part 15 provides two opposite shift ends 153, the casing 10 provides two opposite through holes 121 corresponding to the shift ends 153, and the two shift ends 153 pass through the through holes 121 respectively to extend outward the casing 10; the slide part 15 has a bottom 152 to join with the light guide unit 60 and the second reflection unit 70, respectively. Hence, no details will be described further.

The casing 10 has a lower periphery wall 12 to provide the two through holes 121; the shift ends 153 pass through the through holes 121 to extend outward the periphery wall 12. The slide part 14 in the first and second embodiments can be replaced with the slide part 15 of the present embodiment instead.

It can be seen in FIG. 9 that due to that the shift ends 153 at the two opposite sides of the slide part 15 are moved to different positions in the two through holes 121, it causes that the upper side 151 of the slide part 15 blocks or does not block the first opening 111 and the first reflection unit 20, the light guide unit 60 and the second reflection unit 70 are driven; under the circumferences, the first reflection unit 20 is positioned above at least one LED flash 52 or not above the LED flash 52, and the second reflection unit 70 is positioned above the hologram 80 or not above the hologram 80.

When the slide part 15 blocks the first opening 111, the first reflection unit 20 is located right over the LED flash 52, and the light 521 projected by the LED flash 52 is reflected to the light guide unit 60 and then guided to the second reflection unit 70 to shoot the hologram 80 by the light guide unit 60 such that hologram figures 81 appear above the hologram 80 as shown in FIG. 8.

The slide part 14 shown in FIG. 1 and the slide part 15 shown in FIG. 9 are two structures disclosed in the preceding embodiments of the invention for the slide part to block or open the first opening 111. However, there are many different types of slide parts which will not be numerated in detail here; it is noted that any ways with the slide part blocking or not blocking the first opening 111 are belonged to the range of the claimed invention in addition to those described in the embodiments of the invention.

It can be seen in FIG. 10 that it is required that the light source 91 of the conventional hologram 90 is disposed far away from the hologram 90 to satisfy the necessary optical path in order for the hologram to show the hologram FIGS. 92. If the LED flash on a portable electronic apparatus is employed to project the hologram directly for displaying the hologram figures, a longer vertical distance between the LED flash and the hologram has to be met. Nevertheless, requirements of thinness, shortness, and smallness for the portable electronic apparatus are not possible to be met with the longer vertical distance between the LED flash and the hologram.

Multiple reflection units and light guide units are employed in the thin light guide device applying LED flash on a portable electronic apparatus according to the present invention to satisfy the required optical path between the LED flash and the hologram. Accordingly, the light emitting from the LED flash projecting the hologram indirectly with the shown hologram figures in addition to meeting requirements of thinness, shortness. and smallness for the portable electronic apparatus can obtained.

The reflection unit such as a mirror changing the forward direction of the light emitting from the LED flash and the light guide unit such as the backlight, light guide plate, light guide stick, light guide chamber with reflective interior, or optical fiber guiding the light to where it is needed are utilized in the claimed invention. Thereby, the light from the LED flash is capable of offering functions of illumination, projecting the display, decorating the portable electronic apparatus or projecting the hologram to enhance functions of the LED flash.

It is appreciated that application software compatible with the thin light guide device of the present invention can be downloaded to the portable electronic apparatus to control the operation system thereof; when there are coming calls, the LED flash emits the light with controlled brightness and frequency in accordance with the phone numbers of the coming calls; that is, the figures displayed by the display unit, the hologram figures shown by the hologram, or the decorative figures for the portable electronic apparatus offer effects in different brightness and frequencies based on different phone numbers of the coming calls.

Although the invention has been described in relation to its preferred embodiments, it is to be understood that many other possible modifications and variations can be made without departing from the spirit and scope of the invention as hereinafter claimed.

What is claimed is:

1. A thin light guide device applying LED flash on a portable electronic apparatus, comprising:
a casing having an upper wall and a lower periphery wall, wherein the lower periphery wall joining with the upper wall to form a containing space, the upper wall has a first opening being disposed to correspond to at least one LED flash;
at least a light guide unit being placed in the containing space;
at least a first reflection unit being placed in the containing space and disposed beside said light guide unit to correspond to said LED flash;
a slide part being associated with said casing, and having a lower side;
wherein said light guide unit is joined to said casing or the lower side of said slide part; the lower side of said slide part is joined to said first reflection unit and capable of moving with respect to the casing along a direction toward to block or not block the first opening; said reflection unit is positioned above said LED flash with an angle inclining to a light emitting from said LED flash to change a forward direction of said light and reflect said light to a lateral side of said light guide unit, and said light is guided to where is needed by said light guide unit at the time of said slide part blocking the first opening; said light projects through the first opening at the time of said slide part without blocking the first opening.

2. The thin light guide device applying LED flash on a portable electronic apparatus as defined in claim 1, wherein said upper wall has a second opening; said light guide unit, which is a backlight, is disposed corresponding to said second opening with a light reflection structure provided at the bottom side of said backlight to guide said light toward a direction above said backlight so as to allow said light shooting through said second opening.

3. The thin light guide device applying LED flash on a portable electronic apparatus as defined in claim 1 further comprises a display unit wherein said upper wall is provided with a second opening; said display unit is associated with said casing, disposed above said light guide unit to correspond to second opening, and visible from exterior of said casing; said light guide unit is a backlight with a reflection structure provided at the bottom side of said backlight plate to guide said light toward a direction above said backlight so as to shoot said display unit with bright figures on said display unit.

4. The thin light guide device applying LED flash on a portable electronic apparatus as defined in claim 3, wherein said display unit blocks said second opening.

5. The thin light guide device applying LED flash on a portable electronic apparatus as defined in claim 1, wherein said light guide unit joins with the lower side of said slide part.

6. The thin light guide device applying LED flash on a portable electronic apparatus as defined in claim 2, wherein said light guide unit joins with the lower side of said slide part.

7. The thin light guide device applying LED flash on a portable electronic apparatus as defined in claim 3, wherein said light guide unit joins with the lower side of said slide part.

8. The thin light guide device applying LED flash on a portable electronic apparatus as defined in claim 4, wherein said light guide unit joins with the lower side of said slide part.
